(19) United States
(12) Patent Application Publication
(10) Pub. No.: US 2013/0305544 A1
(43) Pub. Date: Nov. 21, 2013

(54) KNOCKOUT DRIVER APPARATUS

(71) Applicant: Edward A. Haase, South Milwaukee, WI (US)

(72) Inventor: Edward A. Haase, South Milwaukee, WI (US)

(73) Assignee: ACTUANT CORPORATION, Menomonee Falls, WI (US)

(21) Appl. No.: 13/893,789

(22) Filed: May 14, 2013

Related U.S. Application Data
(60) Provisional application No. 61/648,879, filed on May 18, 2012.

(51) Int. Cl. B26F 1/38

(52) U.S. Cl. CPC B26F 1/386
USPC 30/360

(57) ABSTRACT

An apparatus receives power from a prime mover to move a punch relative to a die and thereby form a hole in a wall. The apparatus includes a draw stud that translates to move the punch relative to the die to form the hole. The draw stud is detachable from the apparatus by driving the draw stud such that a key exits a keyway, rotating the draw stud to detach the draw stud from a transmission element, and thereafter removing the draw stud from a draw stud passageway.

### CROSS-REFERENCE TO RELATED APPLICATION

This claims the benefit of U.S. Provisional Patent Application No. 61/648,879 filed May 18, 2012, which is hereby incorporated by reference.

### STATEMENT CONCERNING FEDERALLY SPONSORED RESEARCH OR DEVELOPMENT

Not applicable.

### BACKGROUND OF THE INVENTION

The present invention relates to knockout drivers for forming wire and cable routing holes in walls of electrical panels, distribution boxes, troughs, and the like, particularly knockout drivers that are readily connectible to various types of dies and punches.

Mechanical knockout driver devices are commonly used to form holes in walls of various structures (e.g., electrical panels, distribution boxes, troughs, and the like) after forming an initial hole using a stepped drill bit. Typically, knockout driver devices transmit power from a prime mover (e.g., a hand-held driver/drill) to move a punch towards a die on an opposite side of the initial hole. The punch and the die thereby apply shearing forces to the wall and form a final hole therein. Advantageously, such processes are relatively quick and form relatively uniform holes.

Unfortunately, previous knockout driver devices lack versatility. In particular, draw studs that drive the punches are only suitable for use with knockout sets of certain sizes, which in turn limits the number of different hole sizes that can readily be formed by an operator. Furthermore, draw studs are not easily replaceable or interchangeable with other draw studs for use with other knockout sets. Instead, the draw stud must be replaced or interchanged by special service (e.g., returning the device to the manufacturer or another approved facility). This procedure is inconvenient and significantly reduces the usefulness of knockout driver devices.

Considering the limitations of the previous knockout driver devices, a more versatile knockout driver apparatus is needed. In particular, such a knockout driver preferably has an easily replaceable and interchangeable draw stud and is configured for use with various knockout sets.

### SUMMARY OF THE INVENTION

In one aspect, the present invention provides an apparatus for receiving power from a prime mover to move a punch relative to a die and thereby form a hole in a wall. The apparatus includes a housing that defines a transmission chamber and a draw stud passageway in communication with the transmission chamber. The draw stud passageway includes a keyway that extends in a longitudinal direction of the housing. An input element is rotatably supported by the housing in the transmission chamber and is configured to be rotatably driven by the prime mover. A transmission element is rotatably supported by the housing in the transmission chamber and is rotatably driven by the input element. The transmission element includes a threaded inner surface. A draw stud is supported by the housing in the draw stud passageway and is configured to support the punch proximate the die. The draw stud has a threaded outer surface connected to the threaded inner surface and a key received in the keyway. The key and the keyway inhibit rotation of the draw stud as the transmission element rotates and the threaded inner surfaces threadingly drive the threaded outer surface as the transmission element rotates to cause translation of the draw stud in the longitudinal direction to thereby move the punch relative to the die to form the hole. The draw stud is detachable from the apparatus by only driving the draw stud such that the key exits the keyway, rotating the draw stud to detach the draw stud from the transmission element, and thereafter removing the draw stud from the draw stud passageway.

In another aspect, the present invention provides an apparatus for receiving power from a prime mover to move a punch relative to a die and thereby form a hole in a wall. The apparatus includes a housing that defines a transmission chamber and a draw stud passageway in communication with the transmission chamber. The draw stud passageway includes a keyway that extends from the transmission chamber in a longitudinal direction to a distal end of the housing configured to support the die. An input element is rotatably supported by the housing in the transmission chamber and is configured to be rotatably driven by the prime mover. A transmission element is rotatably supported by the housing in the transmission chamber and is rotatably driven by the input element. The transmission element includes a threaded inner surface. A draw stud is supported by the housing in the draw stud passageway and is configured to support the punch proximate the die. The draw stud has a threaded outer surface connected to the threaded inner surface and a key received in the keyway. The key and the keyway inhibit rotation of the draw stud as the transmission element rotates and the threaded inner surface threadingly drives the threaded outer surface as the transmission element rotates to cause translation of the draw stud in the longitudinal direction to thereby move the punch relative to the die to form the hole.

In yet another aspect, the present invention provides an apparatus for receiving power from a prime mover to move a punch relative to a die and thereby form a hole in a wall. The apparatus includes a housing having a transmission section and a grip section configured to support the die and to be grasped by an operator while using the apparatus for forming the hole in the wall. The grip section has a proximal end connected to the transmission section and a distal end opposite the proximal end, and the grip section defines an internal passageway extending in a longitudinal direction between the proximal end and the distal end. The internal passageway has a longitudinally-extending keyway extending from the proximal end to the distal end. An input element is rotatably supported by the transmission section and is configured to be rotatably driven by the prime mover. A transmission element is rotatably supported by the transmission section and is rotatably driven by the input element, and the transmission element includes a threaded inner surface. A draw stud is supported in the internal passageway and is configured to support the punch proximate the die. The draw stud has a threaded outer surface connected to the threaded inner surface and a key received in the keyway. The key and the keyway inhibit rotation of the draw stud as the transmission element rotates and the threaded inner surface threadingly drives the threaded outer surface as the transmission element rotates to cause translation of the draw stud in the longitudinal direction to thereby move the punch relative to the die to form the hole.

The foregoing and other advantages of the invention will appear in the detailed description which follows. In the description, reference is made to the accompanying drawings which illustrate a preferred embodiment of the invention.

### BRIEF DESCRIPTION OF THE DRAWINGS

The invention will hereafter be described with reference to the accompanying drawings, wherein like reference numerals denote like elements, and:

FIG. 1 is a side view of a knockout driver apparatus according to the present invention receiving power from a prime mover to drive a punch towards a die and thereby form a hole in a wall;

FIG. 2 is a front perspective view of the knockout driver apparatus of FIG. 1;

FIG. 3 is a rear perspective view of the knockout driver apparatus of FIG. 2;

FIG. 4 is a section view of the knockout driver apparatus along line 4-4 of FIG. 1;

FIG. 5 is a section view of the knockout driver apparatus along line 5-5 of FIG. 1;

FIG. 6 is a section view of a draw stud of the knockout driver apparatus along line 5-5 of FIG. 1;

FIG. 7 is a section view of a second embodiment of the knockout driver apparatus according to the present invention.

### DETAILED DESCRIPTION OF THE PREFERRED EMBODIMENT

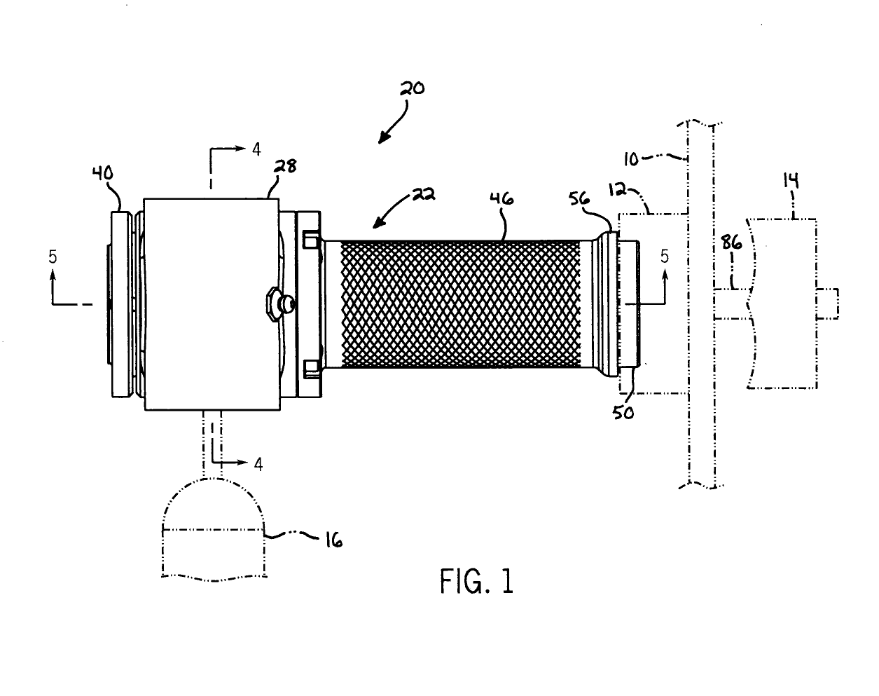

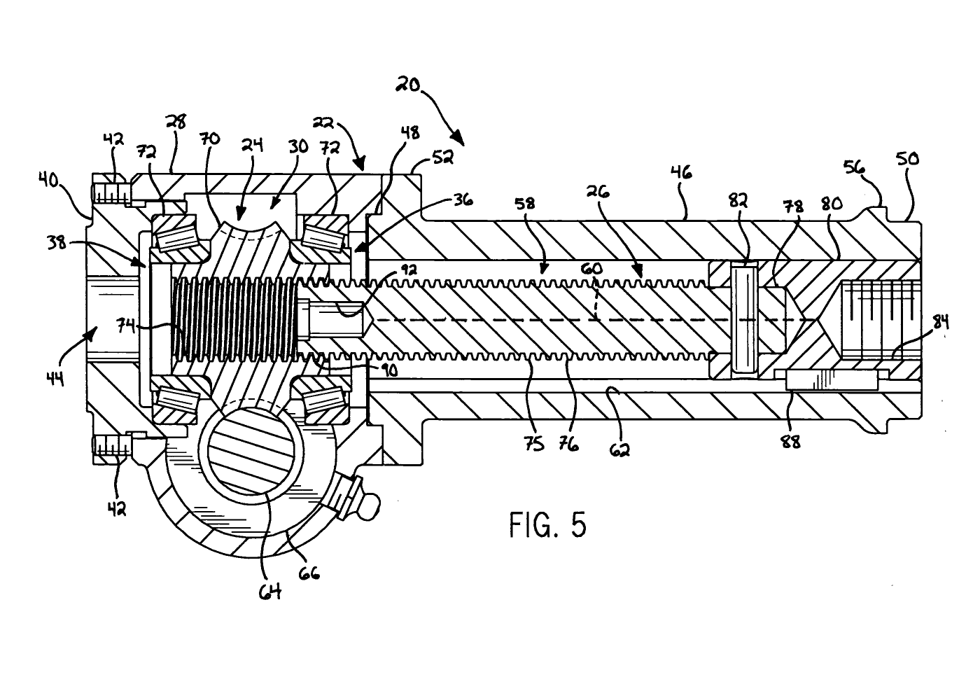

Referring now to the figures and particularly FIGS. 1 and 5, the present invention provides a knockout driver apparatus 20 for forming a hole in a wall 10 (e.g., a wall of a metal electrical panel, distribution box, trough, or the like) using a stationary die 12 and a relatively movable punch 14 (i.e., a “knockout set”). The knockout driver apparatus 20 generally includes a housing 22 that detachably supports the die 12. The housing 22 also supports a transmission assembly 24 that drives a translatable draw stud 26, and the draw stud 26 detachably supports the punch 14. As such, when the punch 14 is connected to the draw stud 26 on the opposite side of the wall 10 from the die 12, the draw stud 26 is translatable to move the punch 14 towards the die 12 and apply shearing forces to the wall 10 to form the hole therein.

Unlike previous designs, the draw stud 26 may be relatively easily detached from the housing 22 and the transmission assembly 24 by an end user (i.e., an operator using the apparatus 20 to form the hole). As such, special servicing is not needed to replace or interchange the draw stud 26 with another draw stud. Furthermore, the apparatus 20 includes features that provide a “dual-drive” structure in which auxiliary knockout sets of different sizes can be used without interchanging the draw stud 26. These advantageous aspects of the knockout driver apparatus 20, in addition to further details of the above components, are described in detail below.

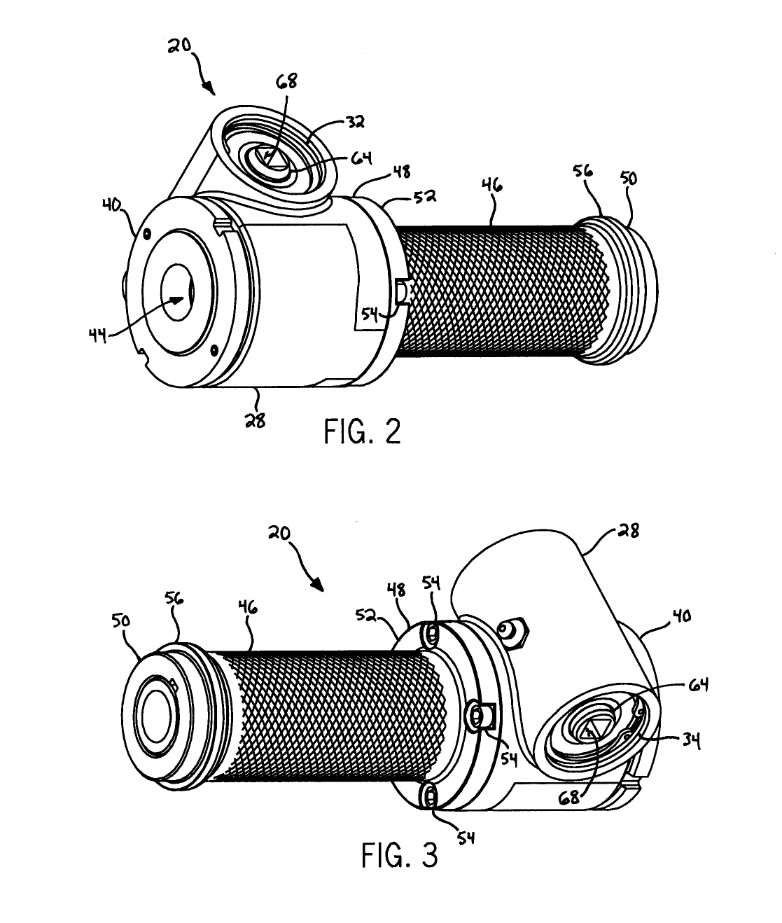

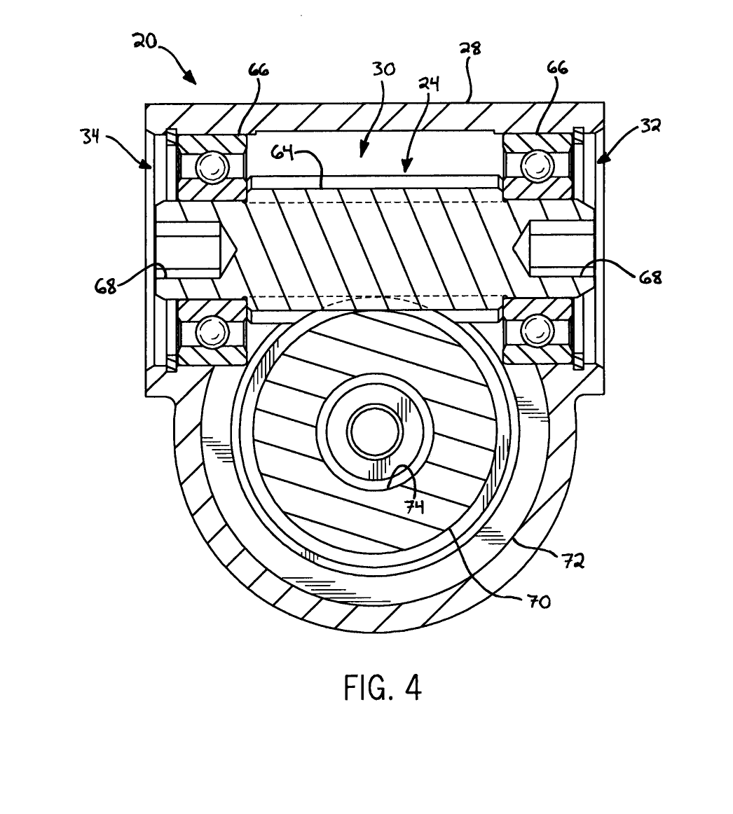

Referring to FIGS. 2-5 and turning first to the housing 22, this component comprises a durable material (e.g., machined or cast aluminum) and includes various sections for supporting the transmission assembly 24 and the draw stud 26. In particular, the housing 22 includes a transmission section 28 that defines a transmission chamber 30. As the names implies, the transmission chamber 30 houses the transmission assembly 24. The transmission section 28 also includes first and second driver openings 32 (FIGS. 2 and 4), 34 (FIGS. 3 and 4) in communication with the transmission chamber 30 and through which the transmission assembly 24 may be driven by a prime mover (e.g., a hand-held driver/drill 16, FIG. 1). Furthermore, the transmission section 28 includes first and second draw stud openings 36, 38 (FIG. 5) in communication with the transmission chamber 30 and through which the draw stud 26 may extend.

The transmission section 28 connects to a cover 40 disposed in the second draw stud opening 38. The cover 40 detaches from the transmission section 28 (e.g., by detaching a plurality of fasteners 42, FIG. 5, such as set screws or the like) to permit access to the transmission chamber 30 and the transmission assembly 24 (e.g., to initially place components of the transmission assembly 24 in the chamber 30 or to service the transmission assembly 24). The cover 40 also defines an access opening 44 that provides access to the draw stud 26 without detaching the cover 40.

Opposite the cover 40, the transmission section 28 connects to a grip section 46 that may be grasped by an operator while forming the hole and transporting the apparatus 20. To this end, the grip section 46 has an elongated and generally cylindrical shape that extends from a proximal end 48 connected proximate the first draw stud opening 36 to an opposite distal end 50.

Externally, the grip section 46 includes a first flange 52 proximate the proximal end 48 that abuts the transmission section 28. The first flange 52 may receive a plurality of fasteners 54 (e.g., socket head cap screws or the like) that secure the grip section 46 to the transmission section 28. Opposite the first flange 52, the grip section 46 also includes a second flange 56 proximate the distal end 50 that abuts the die 12.

Internally, the grip section 46 translatably supports the draw stud 26 in a draw stud passageway 58. The draw stud passageway 58 extends from the proximal end 48 to the distal end 50 of the grip section 46 and defines a longitudinal axis or direction 60 in which the draw stud 26 moves. To facilitate movement of the draw stud 26 in the longitudinal direction 60, the draw stud passageway 58 includes a keyway 62 (e.g., a square cross-sectional channel) that longitudinally extends from the proximal end 48 to the distal end 50. This aspect is described in further detail below.

Referring now to FIGS. 4 and 5 and turning to the transmission assembly 24, this set of components receives power from the prime mover (e.g., the hand-held driver/drill 16) to translate the draw stud 26 and the punch 14 to form the hole. The transmission assembly 24 includes an input element 64 (e.g., a steel worm that rotates about an axis perpendicular to the longitudinal axis 60) disposed in the transmission chamber 30. The ends of the input element 64 are rotatably supported in the first and second driver openings 32, 34 (e.g., by ball bearings 66 (FIG. 4)). Each of the ends also includes an interface 68 (e.g., a square cross-sectional blind hole) to connect to the prime mover.

The input element 64 drives a transmission element 70 (e.g., a steel worm gear that rotates about the longitudinal axis 60) disposed in the transmission chamber 30. The ends of the transmission element 70 are rotatably supported, e.g., by tapered roller bearings 72 (the transmission section 28 supports one of the bearings 72, and the cover 40 supports the other bearing 72). The transmission element 70 includes a threaded inner surface 74 (e.g., an Acme screw thread) to connect to the draw stud 26 as described below.

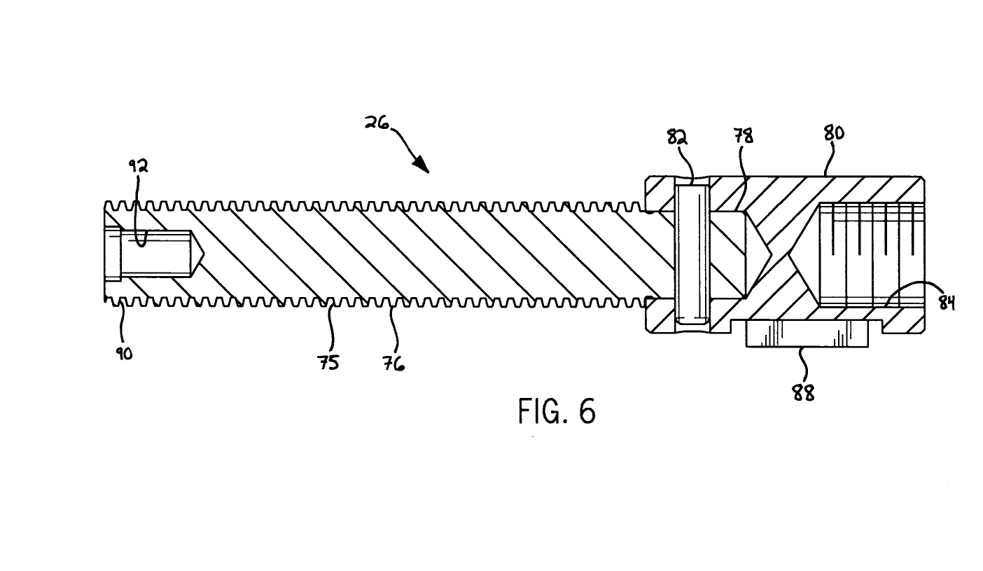

Referring to FIGS. 5 and 6 and turning to the draw stud 26, as described briefly above, this component is translatable to move the punch 14 towards the die 12 and apply shearing forces to the wall 10 to form the hole therein. For this reason, the draw stud 26 comprises a material capable of withstanding the shearing forces applied to the wall, e.g., steel.

To engage the transmission element 70, the draw stud 26 includes an elongated shaft 75 that has a threaded outer surface 76 (e.g., an Acme screw thread). The threaded outer surface 76 engages and is movable over the threaded inner surface 74 of the transmission element 70 to translate the draw stud 26 in the draw stud passageway 58.

To connect to the punch 14, a distal end 78 of the draw stud 26 opposite the transmission element 70 connects to a coupling 80, e.g., via a pin-in-slot connection 82. The coupling 80 includes a longitudinally-opening threaded blind hole 84 that detachably connects to a threaded draw stud adapter 86 (FIG. 1) that supports the punch 14.

The coupling 80 also inhibits the draw stud 26 from rotating as the transmission element 70 rotates. To this end, the coupling 80 supports a radially extending key 88 that is received in the keyway 62. As such, as the transmission element 70 rotates, the threaded inner surface 74 threadingly drives the threaded outer surface 76 and thereby translates the draw stud 26 in the longitudinal direction 60. As the draw stud 26 moves to the left (as shown in FIG. 5), the punch 14 moves towards the die 12 and applies shearing forces to the wall 10 to form the hole therein.

Advantageously, the draw stud 26 may be detached from the apparatus 20 (and thereafter replaced or interchanged with another draw stud) by driving the draw stud 26 such that the key 88 exits the keyway 62, rotating the draw stud 26 to detach the draw stud 26 from the transmission element 70 (e.g., manually rotating the draw stud 26 while the transmission element 70 is stationary), and then removing the draw stud 26 from the draw stud passageway 58. The keyway 62 facilitates such an advantage by extending over the entire length of the housing grip section 46 (that is, from the proximal end 48 to the distal end 50).

To further provide a versatile apparatus 20, the opposite end of the apparatus 20 may support an auxiliary knockout set (not shown) having a different size than the knockout set 12, 14. To this end, the housing cover 40 may support an auxiliary die, and a proximal end 90 of the draw stud 26 opposite the coupling 80 includes a longitudinally-opening auxiliary threaded blind hole 92. This auxiliary threaded blind hole 92 has a different size than the threaded blind hole 84 of the coupling 80. As such, the proximal end 90 of the draw stud 26 may connect to threaded draw stud adapters (not shown) capable of supporting an auxiliary punch. Nevertheless, the transmission assembly 24 translates the draw stud 26 to form a hole using the auxiliary knockout set.

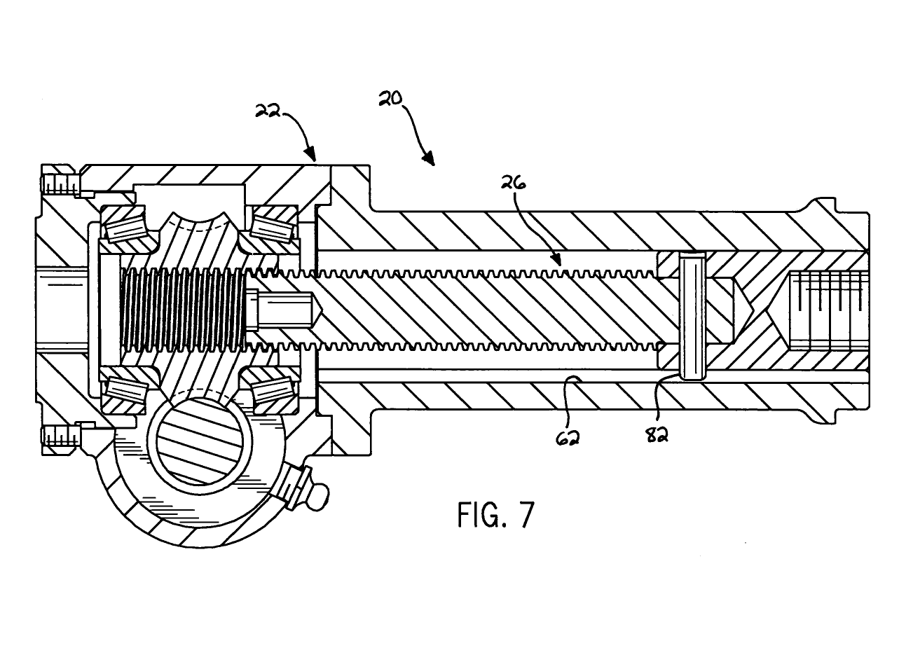

The apparatus 20 may be altered in manners that are not explicitly described above. For example and referring to FIG. 7, the key 88 (FIG. 5) may be omitted and the pin 82 may serve as a key by extending into and moving through the keyway 62. The pin 82 is pressed into the holes through the draw stud 26 and the coupling 80, so it will not fall out if it is extended past the end 50 of the grip section 46.

From the above disclosure, it should be apparent that the present invention provides a knockout driver apparatus in which the draw stud may be relatively easily detached by an end user. As such, special servicing is not needed to replace or interchange the draw stud with another draw stud. Furthermore, the present invention provides a knockout driver apparatus including features that provide a dual-drive structure in which auxiliary knockout sets can be used without interchanging the draw stud.

A preferred embodiment of the invention has been described in considerable detail. Many modifications and variations to the preferred embodiment described will be apparent to a person of ordinary skill in the art. Therefore, the invention should not be limited to the embodiment described, but should be defined by the claims that follow.

I claim:

1. An apparatus for receiving power from a prime mover to move a punch relative to a die and thereby form a hole in a wall, the apparatus comprising:
a housing defining:
a transmission chamber:
a draw stud passageway in communication with the transmission chamber and including a keyway that extends in a longitudinal direction of the housing;
an input element rotatably supported by the housing in the transmission chamber and configured to be rotatably driven by the prime mover;
a transmission element rotatably supported by the housing in the transmission chamber and rotatably driven by the input element, the transmission element including a threaded inner surface;
a draw stud supported by the housing in the draw stud passageway and configured to support the punch proximate the die, the draw stud having a threaded outer surface connected to the threaded inner surface and a key received in the keyway, the key and the keyway inhibiting rotation of the draw stud as the transmission element rotates and the threaded inner surface threadingly driving the threaded outer surface as the transmission element rotates to cause translation of the draw stud in the longitudinal direction to thereby move the punch relative to the die to form the hole; and
wherein the draw stud is detachable from the apparatus by only driving the draw stud such that the key exits the keyway, rotating the draw stud to detach the draw stud from the transmission element, and thereafter removing the draw stud from the draw stud passageway.

2. The apparatus of claim 1, wherein the input element is a worm and the transmission element is a worm gear.

3. The apparatus of claim 1, wherein the punch is a first punch, and the draw stud includes:
a distal end configured to support the first punch; and
a proximal end opposite the distal end and configured to support a second punch having a different size than the first punch.

4. The apparatus of claim 3, wherein the distal end of the draw stud includes a first threaded inner surface configured to support the first punch, and the proximal end of the draw stud includes a second threaded inner surface configured to support the second punch.

5. The apparatus of claim 1, wherein the housing defines an access opening opposite the draw stud passageway providing access to the proximal end of the draw stud.

6. The apparatus of claim 1, wherein the draw stud includes:
a shaft having the threaded outer surface; and
a collar connected to the shaft so as to move with the shaft, the collar supporting the key and being configured to support the punch.

7. An apparatus for receiving power from a prime mover to move a punch relative to a die and thereby form a hole in a wall, the apparatus comprising:
a housing defining:
a transmission chamber:
a draw stud passageway in communication with the transmission chamber and including a keyway that extends from the transmission chamber in a longitudinal direction to a distal end of the housing configured to support the die;
an input element rotatably supported by the housing in the transmission chamber and configured to be rotatably driven by the prime mover;
a transmission element rotatably supported by the housing in the transmission chamber and rotatably driven by the input element, the transmission element including a threaded inner surface; and
a draw stud supported by the housing in the draw stud passageway and configured to support the punch proximate the die, the draw stud having a threaded outer surface connected to the threaded inner surface and a key received in the keyway, the key and the keyway inhibiting rotation of the draw stud as the transmission element rotates and the threaded inner surface threadingly driving the threaded outer surface as the transmission element rotates to cause translation of the draw stud in the longitudinal direction to thereby move the punch relative to the die to form the hole.

8. The apparatus of claim 7, wherein the input element is a worm and the transmission element is a worm gear.

9. The apparatus of claim 7, wherein the punch is a first punch, and the draw stud includes:
a distal end configured to support the first punch; and
a proximal end opposite the distal end and configured to support a second punch having a different size than the first punch.

10. The apparatus of claim 9, wherein the distal end of the draw stud includes a first threaded inner surface configured to support the first punch, and the proximal end of the draw stud includes a second threaded inner surface configured to support the second punch.

11. The apparatus of claim 9, wherein the housing defines an access opening opposite the draw stud passageway providing access to the proximal end of the draw stud.

12. The apparatus of claim 7, wherein the draw stud includes:
a shaft having the threaded outer surface; and
a collar connected to the shaft so as to move with the shaft, the collar supporting the key and being configured to support the punch.

13. The apparatus of claim 7, wherein the draw stud is detachable from the apparatus by only driving the draw stud such that the key exits the keyway, rotating the draw stud to detach the draw stud from the transmission element, and thereafter removing the draw stud from the draw stud passageway.

14. An apparatus for receiving power from a prime mover to move a punch relative to a die and thereby form a hole in a wall, the apparatus comprising:
a housing including:
a transmission section;
a grip section configured to support the die and to be grasped by an operator while using the apparatus for forming the hole in the wall, the grip section having a proximal end connected to the transmission section and a distal end opposite the proximal end, the grip section defining an internal passageway extending in a longitudinal direction between the proximal end and the distal end, and the internal passageway having a longitudinally-extending keyway extending from the proximal end to the distal end;
an input element rotatably supported by the transmission section and configured to be rotatably driven by the prime mover;
a transmission element rotatably supported by the transmission section and rotatably driven by the input element, the transmission element including a threaded inner surface; and
a draw stud supported in the internal passageway and configured to support the punch proximate the die, the draw stud having a threaded outer surface connected to the threaded inner surface and a key received in the keyway, the key and the keyway inhibiting rotation of the draw stud as the transmission element rotates and the threaded inner surface threadingly driving the threaded outer surface as the transmission element rotates to cause translation of the draw stud in the longitudinal direction to thereby move the punch relative to the die to form the hole.

15. The apparatus of claim 14, wherein the input element is a worm and the transmission element is a worm gear.

16. The apparatus of claim 14, wherein the punch is a first punch, and the draw stud includes:
a distal end configured to support the first punch; and
a proximal end opposite the distal end and configured to support a second punch having a different size than the first punch.

17. The apparatus of claim 16, wherein the distal end of the draw stud includes a first threaded inner surface configured to support the first punch, and the proximal end of the draw stud includes a second threaded inner surface configured to support the second punch.

18. The apparatus of claim 16, wherein the housing defines an access opening opposite the grip section providing access to the proximal end of the draw stud.

19. The apparatus of claim 14, wherein the draw stud includes:
a shaft having the threaded outer surface; and
a collar connected to the shaft so as to move with the shaft, the collar supporting the key and being configured to support the punch.

20. The apparatus of claim 14, wherein the draw stud is detachable from the apparatus by only driving the draw stud such that the key exits the keyway, rotating the draw stud to detach the draw stud from the transmission element, and thereafter removing the draw stud from the internal passageway.
